(19) United States
(12) Patent Application Publication
(10) Pub. No.: US 2006/0024507 A1
(43) Pub. Date: Feb. 2, 2006

(54) Method for preparing a spray urethane skin having a clear coat for vehicle interior trim components and skins made thereby

(75) Inventors: Joseph T. Donatti, Howell, MI (US); Jerome J. Sroka, St. Clair Shores, MI (US); Andrew P. Mellentine, Owosso, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 10/902,520

(22) Filed: Jul. 29, 2004

(51) Int. Cl. A21C 9/04; B28B 7/22; B32B 27/40

(52) U.S. Cl. 428/423.1; 264/255; 425/90

(57) ABSTRACT

Aspects of the present invention include providing a method of making polyurethane composite skins for vehicle interior components, as well as providing the resulting skin. In at least one embodiment, the method comprises providing a clear coat having a show surface and a back surface, and providing a colored aromatic polyurethane skin on the back surface of the clear coat. In at least one embodiment, the clear coat is UV stabilized. In at least another aspect of the present invention embodiment, a method of forming a trim product is provided. The method comprises providing a relatively rigid substrate, securing a polyurethane composite skin made in accordance with the present invention to the substrate, and optionally, providing a foam layer between substrate and the composite skin.

### BACKGROUND OF THE INVENTION

1. Field of the Invention

The present invention relates to spray formed polyurethane skins for vehicle interior trim components and method and systems for manufacturing such skins.

2. Background Art

Skins for interior trim components provide a durable plastic cover for interior trim component structures and their associated foam padding. Vinyl skins for interior trim components of a vehicle are typically made by rotocasting a liquid vinyl composition in a heated mold as it is rotated. It has been proposed and implemented in production processes to add liquid color concentrates into the liquid vinyl composition that is provided to rotational molds in rotational molding operations for armrests and small trim components. Vinyl rotocasting processes are labor intensive and are difficult to control and can result in parts having substantial variations in skin thickness. Vinyl skins are not readily recycled and tend to harden over time that may lead to splits in the skin surface over the life of the vehicle. Vinyl skins are also very sensitive to staining when in contact with polyurethanes and exposed to heat and ultraviolet light from the sun.

Recently, substantial efforts have been made to develop polyurethane skins for interior trim components. Polyurethane skins may be sprayed in a robotic spraying process that may be computer controlled to obtain uniform skin thickness. Aliphatic polyurethane compositions are generally black, dark blue, or gray in color but may also be untinted resulting in an amber color. Aliphatic and aromatic polyurethane compositions may be provided in many different colors. To assure precise color matching to a vehicle interior component, an in-mold coating is preferably applied to the polyurethane skin forming mold prior to spraying the polyurethane composition over the in-mold coating and onto the mold surface. Examples of interior components that may be made by the polyurethane spray forming operation include instrument panels, glove box doors, knee bolsters, door panels, consoles and other interior trim components.

Some vehicle interior components have complex shapes and may include difficult to access areas. For example, instrument panel brows may include a narrow section that cannot be easily and completely coated with an in-mold coating composition. Excessive in-mold coating material that may be applied to the surface of the material is wasted and may form runs or irregularities that can adversely effect part quality. In difficult to access areas, such as sharp radii and undercuts, gaps in the in-mold coating may be formed through which the polyurethane skin material may be visible. Moreover, with normal vehicle use and/or during the manufacturing process, scratching or marring in the in-mold coating may occur through which the polyurethane skin may be visible. If so, it may be necessary to paint the skins after forming in areas where there polyurethane skin is visible through the in-mold coating. Such post painting operations are labor intensive, may not produce the same color and gloss level, and require additional capital investment for post painting operation stations.

There is a need for a flexible and cost effective method of spray forming polyurethane parts with a continuous and complete color even where an in-mold coating is present having gaps or areas of inadequate coverage.

The above problems and needs are addressed by applicant's invention as summarized below.

### SUMMARY OF THE INVENTION

According to at least one embodiment of the present invention, a method of making a polyurethane composite skin for vehicle interior components is provided. The method comprises providing a clear coat having a show surface and a back surface, and providing a colored aromatic polyurethane skin on the back surface of the clear coat.

In a further embodiment of the method, the clear coat is UV stabilized.

According to certain aspects of the present invention, the clear coat is formed by spraying clear coat reactive components at a mold surface.

In certain other embodiments, the skin is formed by spraying aromatic polyurethane reactive components at the mold surface.

In at least one embodiment of the method, the clear coat is on the mold surface prior to the step of spraying the aromatic polyurethane reactive components.

According to another embodiment of the present invention, a polyurethane composite skin for interior components is provided. The composite skin comprises a colored aromatic polyurethane skin and a clear coat over the skin.

In a further embodiment of the system, a trim product comprises a rigid substrate and the composite skin described herein over the rigid substrate.

These and other aspects of the present invention will be readily understood by one of ordinary skill in the art in view of the attached drawings and following detailed description of the preferred embodiments of the present invention.

### BRIEF DESCRIPTION OF THE DRAWINGS

FIG. 1 is a cross-sectional view of a trim panel made in accordance with at least one embodiment of the present invention; and

FIG. 2 is a schematic elevation view, partially in section, of at least one embodiment of a spray applicator assembly usable in connection with the present invention.

### DETAILED DESCRIPTION OF THE PREFERRED EMBODIMENTS

As required, detailed embodiments of the present invention are disclosed herein. However, it is to be understood that disclosed embodiments are merely exemplary of the invention that may be embodied in various alternative forms. The figures are not necessarily to scale, some features may be exaggerated or minimized to show details of particular components. Therefore, specific structural and functional details disclosed herein are not to be interpreted as limiting, but merely as a representative basis for the claims and/or a representative basis for teaching one skilled in the art to variously employ the present invention. Moreover, except where otherwise expressly indicated, all numerical quantities in this description and in the claims indicating amounts of materials or conditions of reactions and/or use are to be understood as modified by the word “about” in describing the broadest scope of this invention. Practice within the numeral limit stated is generally preferred. Also, unless expressly stated to the contrary, percent, “parts of”, and ratio values are by weight and the description of a group or class of materials as suitable or preferred for a given purpose in connection with the invention implies that mixtures of any two or more members of the group or class may be equally suitable or preferred.

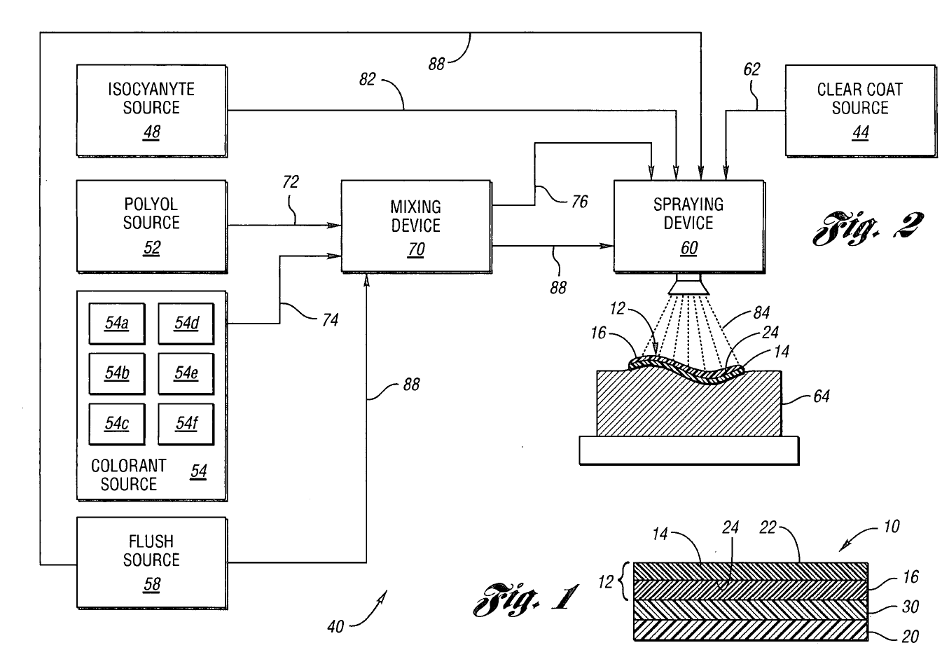

Referring to FIG. 1, a cross section of a trim panel 10, such as an instrument panel, glove box door, knee bolster, door panel and other interior trim component, is shown. In at least one embodiment, the trim panel 10 comprises a composite skin 12 comprising a clear coat 14 over a colored polyurethane skin 16. The clear coat 14 has show surface 22, facing a vehicle interior when in use, and a back surface 24 adjacent to and contacting the skin 16. As shown in the embodiment illustrated in FIG. 1, the trim panel 10 can comprise a rigid substrate 20 such as an ABS, PP (polypropylene), PE (polyethylene), polycarbonate (PC), ABS/PC, or GRU (glass reinforced urethane substrate). Furthermore, a foam layer 30 can optionally be disposed between the substrate 20 and the composite skin 12. In another optional embodiment, the foam layer 30 can be omitted with the composite skin 12 being located directly on the substrate 20.

The clear coat 14 can be formed by any suitable clear coat composition that provides mar resistance, and preferably gloss control, to the colored polyurethane skin 16. In at least one embodiment, a suitable clear coat composition comprises a polyurethane clear coat composition. In at least another embodiment, the polyurethane clear coat composition may further include acrylic resin in addition to polyurethane resin. In at least one embodiment, the clear coat composition is aliphatic.

In at least one embodiment, the clear coat composition may be tinted to act as a processing aid to enable the clear coat composition to be visually seen which can help facilitate a uniform application of the clear coat composition. Additionally, the clear coat composition, when tinted, can provide additional UV resistance. If present, any suitable pigment or dyes can be used to provide tint. Examples of suitable pigments include, but not necessarily limited to, organic, inorganic, milled pigment let down in base polyol and dyes.

In at least one embodiment, the clear coat composition may also include UV stabilizers to protect the trim product 10, and more particularly the colored polyurethane skin 16, from UV degradation. In at least one embodiment, UV levels can vary from 0.25-1.5%, and in other embodiments, from 0.5-1.0%, depending upon pigment/dye color and UV stabilizer type, as measured by color fastness procedure in accordance per SAE J1545, using cie lab color space, 10 degree observer, illuminate D65, specular included, sphere geometry, before and after exposure.

If present, any suitable UV stabilizer can be used. Examples of UV stabilizers suitable for use in the present invention include, but necessarily limited to UV absorbers, UV hindered amine stabilizers, and antioxidants, either alone or in combination. Similar examples of UV absorbers include, but are not necessarily limited to, Tinuvin 571, Tinuvin 213 and Tinuvin 328, available from Ciba Speciality Chemicals of Tarrytown, N.Y. Examples of suitable hindered amine stabilizers include, but are not necessarily limited to, Tinuvin 765, Tinuvin 328, Tinuvin P and Tinuvin 770. Examples of suitable antioxidants include Irganox 1135, Irganox 1010 and Irganox 245 available from Ciba Specialty Chemicals. If present, the UV stabilizers may be provided in a 1% concentration. Examples of suitable UV stabilizer combinations usable with the present invention include, but are not necessarily limited to the follow:
Irganox 245+Tinuvin 328+Tinuvin 765 (1% conc. In 1:2:2 ratio)
Irganox 245+Tinuvin 571+Tinuvin 765 (1% conc. In 1:2:2 ratio)
Irganox 1135+Tinuvin 571+Tinuvin 765 (1% conc. In 1:2:2 ratio)
Irganox 1010+Tinuvin 770+Tinuvin P (1% conc. In 1.5:1:1 ratio)

Some of the Chemical Name for some of the known above stabilizers include:
Irganox 245: Ethylene bis (oxyethylene) bis(3-tert-butyl-hydroxy-5(methylhydrocinnamate)
Irganox 1010: Tertakis (methylene (3,5-di-ter-butyl-4-hydroxyhydrocinnamate)
Irganox 1135: 3,5-Di-tert-butyl-4-hydroxyhydrocinnamic acid, C₇₋₉ branched alkyl esters
Tinuvin P: 2-(2′-Hydroxy-5′-methylphenyl)-benzotriazole
Tinuvin 328: 2-(2H-Benzotriazol-2-yl)-4,6-bis(1,1-dimethylpropyl) phenol
Tinuvin 571: 2-(2H-benzotriazole-2-yl)-6-dodecyl-4-methylphenol, branched and linear
Tinuvin 770: bis(2,2,6,6-Tetramethyl-4-piperidinyl)sebacate
Tinuvin 765: bis(1,2,2,6,6,-Pentamethyl-4-piperidinyl) sebacate)

The UV clear coat composition may also include a flattener to control the gloss level of the clear coat 14. If present, any suitable flattener can be used. The flattener level can vary as needed. In at least one embodiment, the gloss level can range from 1.0-12.0 gloss units, and in other embodiments from 1.0-10.0, when measured by a standard gloss meter at 60° angle to the surface of the skin. A BYK Gardner micro-tri gloss (CAT No. 452D) and micro-gloss 60 (CAT No. 4502) may be used to measure the gloss. Examples of suitable flattener include, but not necessarily limited to, calcium silicate, calcium carbonate and magnesium silicate. In at least one embodiment, a particularly preferred flattener comprises calcium silicate.

In at least one embodiment, the clear coat composition usable with the present invention comprises:

| COMPONENT | WEIGHT % |
|---|---|
| Aliphatic Urethane Resin Solution | 15-35% |
| Acrylic Resin Solution | 0-10% |
| Pigment | 0-15% |
| Flattener | 0-10% |
| Solvents | 40-85% |
| Leveling Agent | 0-5% |
| UV Stabilizer | 0-10% |

In at least one embodiment, the aliphatic urethane resin is a water based resin provided in solution. Suitable urethane resin solutions may contain 35 to 65% solids. Suitable water based urethane resins include, but are not necessarily limited to, resins that provide at least one or more suitable physical properties, such as flexibility, chemical resistance, mar resistance and tensile strength. In at least one embodiment, the urethane resin has a molecular weight of 100 to 4,500, and in other embodiments of 500 to 1,000. In at least one embodiment, the urethane resin has a viscosity of 15 to 40 seconds as measured with a Zahn Cup #2. Suitable urethane resin solutions available from suitable sources such as Red Spot Paint And Varnish Co., Inc. of Plymouth, Michigan and Titan Finishes Corp. of Detroit, Mich.

In at least one embodiment, wherein an acrylic resin is present, the acrylic resin is a water based resin provided in solution. Suitable acrylic resin solutions may contain 10 to 50% solids. In at least one embodiment, if an acrylic resin is present, the acrylic resin provides at least one or more suitable physical properties, such as flexibility, durability and chemical resistance. In at least one embodiment, if an acrylic resin is present, a suitable acrylic resin may include reactive crosslinking functionality, such as acid or hydroxyl, such as Sta-Clad® and Arolon 6433 available from Reichold Chemical, Inc. of Fort Lee, N.J.

Any suitable solvents can be used. In at least one embodiment, a particularly preferred solvent comprises water either alone or in combination with other suitable solvents. Other solvents that can be used include, but are not necessarily limited to other solvents such as N-methyl pryrroliodone (NMP), butyl cellusolve, acetone, 2-butanol, 2-propanol and formaldehyde.

If present, any suitable leveling agent can be used. Examples of suitable leveling agents comprise sodium silicate.

In at least one particularly preferred embodiment, the UV clear coat composition of the present invention comprises:

| COMPONENT | WEIGHT % |
|---|---|
| Aliphatic Urethane Resin (Water Based) | 22-28% |
| Solution | |
| Acrylic Resin (Water Based) Solution | 3-6% |
| Pigment | 2-10% |
| Flattener (Silicone Dioxide) | 1-3% |
| Water | 40-50% |
| N-methyl pyrrolidone | 8-12% |
| Cullusolve | 2-5% |
| Acetone | 1-5% |
| 2-Butanol | 1-3% |
| 2-Propanol | 1-3% |
| Formaldehyde | 0.1-0.2% |
| Leveling Agent (Sodium Silicate) | 0.1-3% |
| UV Stabilizer (Irganox 245 & Tinuvin | 0.1-1.0% |
| 328 & Tinuvin 765 (1% concentrate in | |
| a 1-2-2 Ratio)) | |

Referring now to FIG. 2, a system 40 for spray forming polyurethane composite skins 12 for vehicle interior trim components 10 is schematically illustrated. A liquid clear coat source 44 is provided. The liquid clear coat source 44 contains liquid clear coat reactive components. Suitable liquid clear coat compositions described above can be used.

A liquid isocyanate source 48 is provided. Any suitable liquid isocyanate, such as an aromatic isocyanate, can be used. Examples of suitable aromatic liquid isocyanates include, but are not necessarily limited to, MDI and TDI. Alternatively, liquid aliphatic isocyanate could also be used. The liquid isocyanate could have suitable additives, such as UV inhibitors/stabilizers, especially if the isocyanate is aromatic. Suitable suppliers of suitable liquid isocyanates include Huntsman of Auburn Hills, Mich.; Bayer Polymers of Pittsburgh, Pa.; and Dow Chemical of Freeport, Tex.

A liquid polyol source 52 is provided. Any suitable liquid polyol can be used. In at least one embodiment, the polyol employed is a polyether polyol. Examples of suitable liquid polyols include, but are not necessarily limited to, graft polyols, PhD polyols, Polymer Polyols, and PIPA polyols. Suitable suppliers of suitable liquid polyols include Dow Chemical of Freeport, Tex.; BASF Corporation of Wyandotte, Mich.; and Bayer Polymer of Pittsburgh, Pa. The liquid polyol could have suitable additives, especially if aliphatic, such as UV and antioxidant inhibitors/stabilizers, such as Irganox 1175, Tinuvin 765 and TIN B-75, from Ciba Specialty Chemicals of Terrytown, N.Y., and Cyasorb® Family UV stabilizers and antioxidants from Cytec Polymers of Stamford, Conn.

At least one liquid colorant source 54 is provided. As shown, the liquid colorant source 54 could include more than one individual sources 54a-f of color. In other words, a plurality of individual liquid colorant sources, 54a-f, each containing a different color, such as red, blue, black, etc, could be provided. Any suitable liquid colorant can be used. Examples of suitable liquid colorants include, but are not necessarily limited to, finely ground pigment dispersed in a liquid component useable in the formation of polyurethane, such as polyol and/or isocyanate. Other suitable colorants, such as liquid dyes, can also be used. Suppliers of suitable colorants include Rite Systems of West Chicago, Ill. and PolyOne of North Baltimore, Ohio. In certain embodiments, the liquid colorant includes a UV stabilizer, such as zinc, benzophones, benzotriazole, and benzoxazione to inhibit UV degradation should the resultant polyurethane skin be exposed to UV light. Other suitable additives could be included, such as, but not necessarily limited to, triazines and radical scavengers, as are available from Ciba Specialty Chemicals and Cytec Polymers. Alternatively, one color could be run for an extended period time to manufacture a plurality of colored skins 16 of the same color. In this case, the polyol could be precolored with this color, alleviating the need for providing separate colorants.

A solvent flush source 58 is provided. Any suitable liquid solvent flush can be used. Suitable solvent flushes include solvents that do not react with the isocyanate and polyol. Examples of suitable liquid solvent flushes include, but are not necessarily limited to MEK (methyl ethyl ketone), DBE (dibasic ester), NMP (Naptha) and mineral spirts, as are available from Ashland Chemical of Dublin, Ohio and Shell Oil Solvents of Kent, Ohio.

A spraying device 60, such as a conventional spray gun, is provided. In a first step, the spraying device receives a stream 62 of clear coat composition from the liquid clear coat source 44. The stream 62 is sprayed from the spraying device 60 onto a spray mold 64 to form a clear coat 14 when dried. In at least one embodiment, the clear coat 14 has an average thickness of 0.25-1.5 mils, and in other embodiments of 0.5-1.0 mils. The clear coat 14 can provide UV resistance to the colored polyurethane layer 16 to meet outdoor exposure requirements of 601.6 to 2,000 KJ/m² as measured by a Xenon weatherometer in accordance with SAE J1885 (Arizona outdoor exposure GM 9538P UG-SJC-XXX per ranging from 50,000-200,000 langleys.

A mixing device 70 is provided. In a second step, the mixing device 70 receives a stream 72 of polyol from the polyol source 52 and a stream of colorant 74 from the colorant source 54. In the mixing device 70 the polyol and the colorant mix to form a colorant/polyol stream 76.

In at least one embodiment, the spraying device 60 receives the colorant/polyol stream 76 and an isocyanate stream 82 from the mixing device 70 and the isocyanate source 48, respectively. In this embodiment, the streams 76 and 82 mix in the spraying device 60 to form a liquid polyurethane composition which is sprayed from the spraying device 60 in the form of a colored polyurethane stream 84. In at least another embodiment, a different and separate spraying device than the one used to spray the clear coat composition could be provided for spraying the colored polyurethane stream 84.

In at least one embodiment, the polyurethane composition is an aromatic composition. The polyurethane stream 84 is directed towards the spray mold 64, and onto the back surface 24 of the clear coat 14, to form a colored polyurethane skin 16, when dried, on top of the clear coat 14. In at least one embodiment, the colored polyurethane skin 16 is aromatic. In at least one embodiment, the colored polyurethane skin 16 has an average thickness of 0.6-1.5 mm, and in other embodiments of 0.8-1.2 mm.

In at least one embodiment, the polyol, isocyanate and the colorants are maintained at elevated temperatures. In certain embodiments, the elevated temperatures are each independently 70-125° F., and in other embodiments 75-95° F. Each of the streams 88 and 92 may be provided at a pressure of between 600 psi and 2,000 psi to the spray device 60.

In at least one embodiment, the colorant (i.e., dye or pigment) is provided in an amount of 1-20 wt. %, based on the total weight of the colorant/polyol stream 76, and in other embodiments an amount of 3-10 wt. %, based on the total weight of the colorant/polyol stream 76. In certain embodiments, the colorant is provided in an amount of 0.5-15 wt. %, based on the total weight of the polyurethane stream 84, and in other embodiments an amount of 1-8 wt. %, based on the total weight of the polyurethane stream 84.

In at least one embodiment of the present invention, the colored polyurethane skin 16 is made by first mixing a stream of polyol 72 with at least one stream of a colorant 74 in the mixing device 70 to form a stream of colorant/polyol 76. In forming the stream of colorant/polyol 76, the appropriate colorant 54a-54f is selected to mix with the stream of polyol 72, depending upon the desired color of the colored polyurethane skin 16. For instance, if the colored polyurethane skin 16 is desired to be blue, a stream of blue colorant (74) is sent to the mixing device 70 from the colorant source 54. In at least one embodiment, a processor (CPU) can be provided to control the operation.

The stream of colorant/polyol 76 is then mixed with the isocyanate stream 82 in a spraying device to form a colored polyurethane composition which is sprayed from the spraying device in the form of a colored polyurethane stream 84 towards the spray mold 64 and onto the back surface 24 of the clear coat 14 to form the colored polyurethane skin 16 of the desired color. In at least one embodiment, after each polyurethane skin 16 is formed, a solvent flush stream 88 is sent from the flush source 58, through the mixing device 70, and through the spraying device 60 to clean the isocyanate, polyol and colorant from the mixing device 70 and the spraying device 60 to prevent clogging of the equipment and/or undesired color mixing. In some embodiments, such as when consecutive runs of the same color polyurethane stream 84 is being used, the flush stream 88 can be sent, if desired, from the flush source 58 directly to the spraying device 60, primarily to prevent clogging. During the flushing step, the spray device 60 delivers a stream of flushant (not shown) into a waste receptacle (not shown) such as a waste bucket. After the spraying device 60 has been flushed, and the composite skin 12 removed from the mold 64, the process can be repeated to form another composite skin 12 (comprising a clear coat 14 and a colored polyurethane skin 16) of a desired color. This process allows the selective control of the colored polyurethane skin 16, and thus the composite skin 12. For instance, a different color could be selected for each successive colored polyurethane skin 16 that is being manufactured. Alternatively, the same color could be used for long production runs of the colored polyurethane skin 16.

In at least one embodiment, the system and the method of the present invention is employed to form the polyurethane composite skin 12. The polyurethane composite skin 12 comprises the colored polyurethane skin 16 and a clear coat 14 over the polyurethane skin 16.

The polyurethane composite skin 12 can form a portion of the trim product 10, such as an instrument panel, glove box door, knee bolster, door panel and other interior trim component. In at least one embodiment, the trim panel 10 comprises the polyurethane composite skin 12 disposed over a foam layer 30 which is disposed over a substrate 20, such an ABS substrate. In at least one embodiment, after a colored polyurethane skin 16 with clear coat 14 is removed from the mold 64, it is put in a forming tool (not shown) with, but spaced from, substrate 20 to allow foam layer 30 to be formed therebetween. It should be understood that the trim product 10 could omit the foam layer 30, as is well known in the art, if a harder trim product 10 is acceptable and/or desirable. Furthermore, it should be understood that the substrate 20 could be formed in a mold with the composite skin 12 having already been placed therein or that the foam layer 30 could be formed by a different process as is known in the art.

While embodiments of the invention have been illustrated and described, it is not intended that these embodiments illustrate and describe all possible forms of the invention. Furthermore, the omission or schematic illustration of conventional equipment, such as pumps, valves, heaters, etc., should not be interpreted as certain convention equipment not being needed or present in the system or as limiting the invention in any manner. Rather, the words used in the specification are words of description rather than limitation, and it is understood that various changes may be made without departing from the spirit and scope of the invention.

What is claimed is:

1. A method of making a polyurethane composite skin for vehicle interior components, said method comprising:
providing a clear coat having a show surface and a back surface; and
providing a colored aromatic polyurethane skin on the back surface of the clear coat.

2. The method of claim 1 wherein the clear coat is UV stabilized.

3. The method of claim 2 wherein the clear coat is formed by spraying aliphatic polyurethane reactive components at a mold surface.

4. The method of claim 3 wherein the skin is formed by spraying aromatic polyurethane reactive components at the mold surface.

5. The method of claim 4 wherein the clear coat is on the mold surface prior to the step of spraying the aromatic polyurethane reactive components.

6. The method of claim 1 wherein the clear coat comprises polyurethane.

7. The method of claim 6 wherein the clear coat reactive components comprise:

| COMPONENT | WEIGHT % |
|---|---|
| Aliphatic Urethane Resin Solution | 15-35% |
| Acrylic Resin Solution | 0-10% |
| Pigment | 0-15% |
| Flattener | 0-10% |
| Solvents | 40-85% |
| Leveling Agent | 0-5% |
| UV Stabilizer | 0-10% |

8. The method of forming a trim product, the method comprises:
providing a relatively rigid substrate; and
securing a polyurethane composite skin to the substrate, the composite skin being made by the process of claim 1.

9. The method of claim 8 further comprising providing a foam layer between substrate and the composite skin.

10. A method of making polyurethane skins for interior components, said method comprising:
providing a mold surface;
spraying an aliphatic clear coat composition at the mold surface to form a clear coat on the mold surface; and
spraying aromatic polyurethane reactive components at the clear coat to form an aromatic polyurethane layer on the clear coat.

11. The method of forming a trim product, the method comprises:
providing a relatively rigid substrate; and
securing a polyurethane composite skin to the substrate, the composite skin being made by the process of claim 10.

12. A system for forming the polyurethane composite skin of claim 1, said system comprising:
a source of sprayable clear coat composition;
a source of colored polyurethane composition;
a spray mold; and
at least one spray device for spraying at least one of the clear coat composition and colored polyurethane composition at the spray mold.

13. The system of claim 12 further comprising a second spray device for spraying the colored polyurethane composition, wherein the at least one spray device sprays the clear coat composition.

14. A polyurethane composite skin for interior components comprising:
a colored aromatic polyurethane skin; and
an aliphatic clear coat over the skin.

15. The skin of claim 14 wherein the clear coat is UV stabilized.

16. The method of claim 15 wherein the skin has an average thickness of 0.6-1.5 mm.

17. The skin of claim 14 wherein the clear coat has an average thickness of 0.25-1.5 mil.

18. The skin of claim 14 wherein the clear coat is formed by spraying clear coat reactive components at a mold surface.

19. The skin of claim 18 wherein the clear coat reactive components comprise:

| COMPONENT | WEIGHT % |
|---|---|
| Aliphatic Urethane Resin Solution | 15-35% |
| Acrylic Resin Solution | 0-10% |
| Pigment | 0-15% |
| Flattener | 0-10% |
| Solvents | 40-85% |
| Leveling Agent | 0-5% |
| UV Stabilizer | 0-10% |

20. A trim product comprising:
a rigid substrate; and
the composite skin of claim 14 over the rigid substrate.
